(19) United States
(12) Patent Application Publication
(10) Pub. No.: US 2017/0204284 A1
(43) Pub. Date: Jul. 20, 2017

(54) HEAT STABLE COATING COMPOSITION, SUBSTRATE, AND PACKAGING

(71) Applicant: MAGNUM MAGNETICS CORPORATION, MARIETTA, OH (US)

(72) Inventor: Brian Hinderer, Marietta, OH (US)

(21) Appl. No.: 14/996,605

(22) Filed: Jan. 15, 2016

(51) Int. Cl. C09D 133/08; B05D 1/28; C09D 125/14

(52) U.S. Cl. CPC C09D 133/08; C09D 125/14; B05D 1/28; C08K 2003/2241

(57) ABSTRACT

A heat resistant bakery white composition, substrate, and packaging. The composition, including titanium dioxide and a soft emulsion polymer based on styrene and acrylates.

### FIELD

A heat stable coating composition containing titanium dioxide and a soft emulsion polymer based on styrene and acrylates. The heat stable coating composition can be used for bakery applications such as a bakery white coating for paper using a rod coater or by flexo and/or gravure printing.

### BACKGROUND

Currently, there exists paper packaging for food use (e.g. bakery products) containing perfluorinated compounds, including perfluoroalkyl sulfonates (PFAS) and long-chain perfluoroalkyl carboxylate (LCPFAC) chemical compounds. There is a desire to provide white coatings for paper packaging for food use that does not contain perfluorinated compounds. The white coatings for bakery applications must be hot-rub resistant and resist discoloration or staining from common bakery items such as butter cream, chocolate icing, olive oil, vegetable oil, peanut butter, coconut oil, Italian dressing, pine nut oil, and cactus oil.

### SUMMARY

The presently described subject matter relates to a composition, a substrate, and packaging. The composition can be a bakery white composition, in particular a heat resistant bakery white composition. For example, the composition can comprise or consist of titanium dioxide and a soft emulsion polymer based on styrene and acrylates, for example, Induprint SE 2457. The composition can further comprise aluminum silicate filler such as a clay (e.g. chemical name kaolin) and zinc oxide (ZnO). The balance of the composition can be water. The heat resistant bakery white composition can be varied for particular applications to provide the best results.

The substrate is a heat resistant substrate, of example, a heat resistant bakery white substrate. For example, the substrate can be treated or applied (e.g. coated) with the bakery white composition. The substrate, for example, can be a paper or film substrate.

The food packaging, for example, is made from the heat resistant bakery white substrate.

The presently described subject matter is directed to a method of making bakery white food packaging substrate comprising or consisting of providing a paper substrate, and coating on at least one side of the paper substrate a bakery white composition.

The presently described subject matter is directed to a method of making bakery white food packaging substrate comprising or consisting of providing a paper substrate, and coating on at least one side of the paper substrate a bakery white composition.

The presently described subject matter is directed to a method of making bakery white food packaging substrate comprising or consisting of providing a paper substrate, and coating on at least one side of the paper substrate a bakery white composition comprising from about 35% to 55% by percent weight titanium dioxide, from about 20% to about 40% by percent weight soft emulsion polymer based on styrene and acrylates, and the balance water.

The presently described subject matter is directed to a method of making bakery white food packaging substrate comprising or consisting of providing a paper substrate, and coating on at least one side of the paper substrate a bakery white composition comprising from about 35% to 55% by percent weight titanium dioxide, from about 20% to about 40% percent weight soft emulsion polymer based on styrene and acrylates, and from about 0.1% to about 20% by percent weight kaolin; and the balance water.

The presently described subject matter is directed to a method of making bakery white food packaging substrate comprising or consisting of providing a paper substrate, and coating on at least one side of the paper substrate a bakery white composition comprising from about 35% to 55% by percent weight titanium dioxide, from about 20% to about 40% by percent weight soft emulsion polymer based on styrene and acrylates, from about 0.1% to about 20% by percent weight kaolin; and from about 0.1% to about 10% by percent weight zinc oxide, and the balance water.

The presently described subject matter is directed to a method of making bakery white food packaging substrate comprising or consisting of providing a paper substrate, and coating on at least one side of the paper substrate a bakery white composition comprising about 47.6% by percent weight titanium dioxide, about 28.7% by percent weight soft emulsion polymer based on styrene and acrylates, about 9.5% by percent weight kaolin; and from about 3.5% by percent weight zinc oxide, and the balance water.

The presently described subject matter is directed to a method of making bakery white food packaging substrate comprising or consisting of providing a paper substrate, and coating on at least one side of the paper substrate a bakery white composition comprising from about 40% to 50% by percent weight titanium dioxide, from about 20% to about 40% by percent weight soft emulsion polymer based on styrene and acrylates, and the balance water.

The presently described subject matter is directed to a method of making bakery white food packaging substrate comprising or consisting of providing a paper substrate, and coating on at least one side of the paper substrate a bakery white composition comprising from about 47.6% by percent weight titanium dioxide, from about 20% to about 40% by percent weight soft emulsion polymer based on styrene and acrylates, and the balance water.

The presently described subject matter is directed to a method of making bakery white food packaging substrate comprising or consisting of providing a paper substrate, and coating on at least one side of the paper substrate a bakery white composition comprising from about 35% to 55% by percent weight titanium dioxide, from about 25% to about 35% by percent weight soft emulsion polymer based on styrene and acrylates, and the balance water.

The presently described subject matter is directed to a method of making bakery white food packaging substrate comprising or consisting of providing a paper substrate, and coating on at least one side of the paper substrate a bakery white composition comprising from about 35% to 55% by percent weight titanium dioxide, about 28.7% by percent soft emulsion polymer based on styrene and acrylates, and the balance water.

The presently described subject matter is directed to a method of making bakery white food packaging substrate comprising or consisting of providing a paper substrate, and coating on at least one side of the paper substrate a bakery white composition comprising from about 35% to 55% by percent weight titanium dioxide, from about 20% to about 40% by percent weight soft emulsion polymer based on styrene and acrylates, from about 0.1% to about 20% by percent weight kaolin, and the balance water.

The presently described subject matter is directed to a method of making bakery white food packaging substrate comprising or consisting of providing a paper substrate, and coating on at least one side of the paper substrate a bakery white composition comprising from about 35% to 55% by percent weight titanium dioxide, from about 20% to about 40% by percent weight soft emulsion polymer based on styrene and acrylates, about 9.5% by percent weight kaolin, and the balance water.

The presently described subject matter is directed to a method of making bakery white food packaging substrate comprising or consisting of providing a paper substrate, and coating on at least one side of the paper substrate a bakery white composition comprising from about 35% to 55% by percent weight titanium dioxide, from about 20% to about 40% by percent weight soft emulsion polymer based on styrene and acrylates, from about 0.1% to about 20% by percent weight kaolin, from about 0.1% to about 10% by percent weight zinc oxide, and the balance water.

The presently described subject matter is directed to a method of making bakery white food packaging substrate comprising or consisting of providing a paper substrate, and coating on at least one side of the paper substrate a bakery white composition comprising from about 35% to 55% by percent weight titanium dioxide, from about 20% to about 40% by percent weight soft emulsion polymer based on styrene and acrylates, from about 0.1% to about 20% by percent weight kaolin, about 3.5% zinc oxide, and the balance water.

The presently described subject matter is directed to a method of making bakery white food packaging substrate comprising or consisting of providing a paper substrate, and coating on at least one side of the paper substrate a bakery white composition comprising from about 35% to 55% by percent weight titanium dioxide, from about 20% to about 40% by percent weight soft emulsion polymer based on styrene and acrylates, and the balance water, wherein the coating is applied by rod coating.

The presently described subject matter is directed to a method of making bakery white food packaging substrate comprising or consisting of providing a paper substrate, coating on at least one side of the paper substrate a bakery white composition comprising from about 35% to 55% by percent weight titanium dioxide, from about 20% to about 40% by percent weight soft emulsion polymer based on styrene and acrylates, and the balance water, and applying an overprint on the coating.

The presently described subject matter is directed to a method of making bakery white food packaging substrate comprising or consisting of providing a paper substrate, coating on at least one side of the paper substrate a bakery white composition comprising from about 35% to 55% by percent weight titanium dioxide, from about 20% to about 40% by percent weight soft emulsion polymer based on styrene and acrylates, and the balance water, and applying a gloss overprint on the coating

The presently described subject matter is directed to a method of making bakery white food packaging substrate comprising or consisting of providing a paper substrate, and printing on at least one side of the paper substrate a bakery white composition comprising from about 35% to 55% by percent weight titanium dioxide, from about 20% to about 40% by percent weight soft emulsion polymer based on styrene and acrylates, and the balance water, and printing on the coating.

The presently described subject matter is directed to a method of making bakery white food packaging substrate comprising or consisting of providing a paper substrate, and coating on at least one side of the paper substrate a bakery white composition comprising from about 35% to 55% by percent weight titanium dioxide, from about 20% to about 40% by percent weight soft emulsion polymer based on styrene and acrylates, and the balance water, wherein the coating is applied by at least one selected from the group consisting of flexo printing and gravure printing.

The presently described subject matter is directed to a method of making bakery white food packaging substrate comprising or consisting of providing a paper substrate, coating on at least one side of the paper substrate a bakery white composition comprising from about 35% to 55% by percent weight titanium dioxide, from about 20% to about 40% by percent weight soft emulsion polymer based on styrene and acrylates, and the balance water, wherein the titanium oxide is Rutile Grade R-F9490.

The presently described subject matter is directed to a method of making bakery white food packaging substrate comprising or consisting of providing a paper substrate, coating on at least one side of the paper substrate a bakery white composition comprising from about 35% to 55% by percent weight titanium dioxide, from about 20% to about 40% by percent weight soft emulsion polymer based on styrene and acrylates, and the balance water, wherein the soft emulsion polymer based on styrene and acrylates is Induprint SE 2457 resin.

The presently described subject matter is directed to a method of making bakery white food packaging substrate comprising or consisting of providing a paper substrate, coating on at least one side of the paper substrate a bakery white composition comprising from about 35% to 55% by percent weight titanium dioxide, from about 20% to about 40% by percent weight soft emulsion polymer based on styrene and acrylates, from about 0.1% to about 20% by percent weight kaolin, and the balance water, wherein the kaolin is Glomax LL.

The presently described subject matter is directed to a heat stable composition comprising or consisting of from about 35% to 55% by percent weight titanium dioxide, from about 20% to about 40% by percent weight soft emulsion polymer based on styrene and acrylates, and the balance water.

The presently described subject matter is directed to a heat stable composition comprising or consisting of from about 35% to 55% by percent weight titanium dioxide, from about 20% to about 40% by percent weight soft emulsion polymer based on styrene and acrylates, and the balance water, wherein the soft emulsion polymer based on styrene and acrylates is Induprint SE 2457.

The presently described subject matter is directed to a heat stable composition comprising or consisting of from about 35% to 55% by percent weight titanium dioxide, from about 20% to about 40% by percent weight soft emulsion polymer based on styrene and acrylates, from about 0.1% to about 20% by percent weight kaolin, and the balance water.

The presently described subject matter is directed to a heat stable composition comprising or consisting of from about 35% to 55% by percent weight titanium dioxide, from about 20% to about 40% by percent weight soft emulsion polymer based on styrene and acrylates, from about 0.1% to about 10% by percent weight zinc oxide, and the balance water.

The presently described subject matter is directed to a heat stable composition comprising or consisting of from about 35% to 55% by percent weight titanium dioxide, from about 20% to about 40% by percent weight soft emulsion polymer based on styrene and acrylates, from about 0.1% to about 20% by percent weight kaolin, from about 0.1% to about 10% by percent weight zinc oxide, and the balance water.

The presently described subject matter is directed to a heat stable composition comprising or consisting of from about 35% to 55% by percent weight titanium dioxide, from about 25% to about 35% by percent weight soft emulsion polymer based on styrene and acrylates, from about 5% to about 15% by percent weight kaolin, from about 2% to about 8% by percent weight kaolin, and the balance water.

The presently described subject matter is directed to a heat stable composition comprising or consisting of about 47.6% by percent weight titanium oxide, about 28.7% by percent weight soft emulsion polymer based on styrene and acrylates, about 9.5% by percent weight kaolin; about 3.5% zinc oxide by percent weight, and the balance water.

The presently described subject matter is directed to a food packaging substrate comprising a paper substrate, and a coating provided on at least one side of the paper substrate, the coating comprising a bakery white composition comprising from about 35% to 55% by percent weight titanium dioxide, from about 20% to about 40% by percent weight soft emulsion polymer based on styrene and acrylates, and the balance water.

### BRIEF DESCRIPTION OF DRAWINGS

FIG. 1 is a Fourier transform infrared (FTIR) spectroscopy of a sample of the soft emulsion polymer based on styrene and acrylates.

FIG. 2 is a Fourier transform infrared (FTIR) spectroscopy of a sample of the heat stable coating composition or finished product.

### DETAILED DESCRIPTION

A method of making a heat resistant substrate, for example, for use in the bakery area. For example, the heat resistant substrate is a bakery white heat resistant substrate for use in making food packaging.

The heat resistant substrate comprises a paper substrate (e.g. paperboard substrate) coated on one or more sides with a heat resistant composition. The coating can be applied in any manner know in the art, for example, by using a blade, air knife, or a rod coater. Alternatively, the coating can be applied by printing on the paper substrate such as by flexo and/or gravure printing using a printing press.

The coatings can be coated on base stock and such coated board can be used for as containers for cooking food. The coated paperboard can be used with a variety of food groups, for example, bakery, meat, fish, pasta, rice, etc.

The heat resistant composition is used to make the heat resistant substrate(s), which can be converted, for example, to make food packaging. The heat resistant composition comprises titanium dioxide (TiO₂) and a soft emulsion polymer based on styrene and acrylates such as Induprint SE 2457.

The titanium dioxide (TiO₂) used in the composition can be TITANIUM DIOXIDE RUTILE (GRADE R-F9490) having a TiO₂ content percent weight of 93% minimum and a Rutile content percent weight of 98.5% minimum. Alternatively, the titanium dioxide (TiO₂) used in the composition, for example, can be TITANIUM DIOXIDE RUTILE (Grade Rutile, Formula TI02), which contains 94.5% minimum by percent weight titanium dioxide and 0-10% by percent weight silica amorphous. The TITANTIUM DIOXIDE RUTILE is supplied by Revellie Chemicals, Inc., Greenwich, Conn.

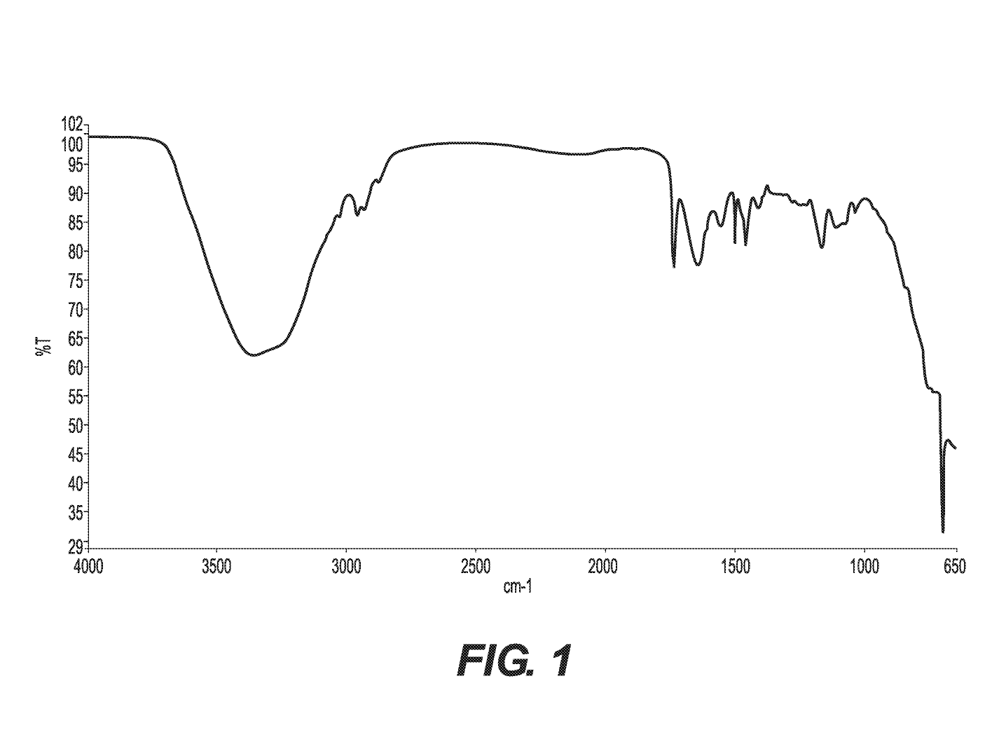

The soft emulsion polymer is based on styrene and acrylates. For example, the soft emulsion polymer can have the Fourier transform infrared (FTIR) spectroscopy shown in FIG. 1. For example, the soft emulsion polymer can be Induprint SE 2457 manufactured/supplied by Indulor Chemie Gmbh, Germany and/or Indulor America, LP, Graham, N.C.).

Induprint SE 2457 can be used as a binder for the titanium dioxide, and is used as a binder for glossy water-based overprint varnishes, and is used as a let-down vehicle for water-based flexographic and gravure-printing inks. Induprint SE 2457 includes the characteristics of having an excellent water resistance, high gloss, excellent pigment wetting, and good adhesion on films and foils.

Induprint SE 2457 has the following properties and/or characteristics:

| | |
|---|---|
| Appearance | white to pale brownish emulsion |
| Solid Contents (DIN EN ISO 3251) | 46-48% by percent weight |
| Viscosity (DIN 53019-1) | 350-800 mPa · s at 25° C. |
| (Anton Paar RheolabQC; MS: CC27; | |
| D = 28.9 s⁻¹) | |
| pH Value (DIN ISO 976) | 7.3-7.6 |
| Glass Temperature (DSC) DIN 51007 | approx. 52 mg KOH/g solid |
| MFFT (DIN 53787) | approx. 0° C. |
| Ionicity | anionic |
| Freeze/Thaw Stability | stable |
| Melting point/Melting range | undetermined |
| Boiling point/Boiling range | 120° C. (212° F.) |
| Flash point | not applicable |
| Auto igniting | product is not self-igniting |
| Danger of explosion | product does not present an |
| | explosion hazard |
| Vapor pressure at 20° C. (68° F.) | 23 hPa (17 mm Hg) |
| Density at 20° C. (68° F.) | approx. 1.05 g/cm³ |
| | (approx. = 8.762 lbs/gal) |
| Solubility in/Miscibility with water | fully miscible |
| Viscosity (Dynamic at 20° C. (68° F.) | approx. 700 mPas |

The heat resistant composition can further comprise an aluminum silicate filler such as a clay (e.g. chemical name kaolin) for use in extending the titanium dioxide and improving the brightness of a coating of the heat resistant composition. For example, the aluminum silicate filler is Glomax LL supplied by Imerys, 618 Kaolin Road, Sandersville, Ga. 31082. In addition, the heat resistant composition can also comprise zinc oxide (ZnO).

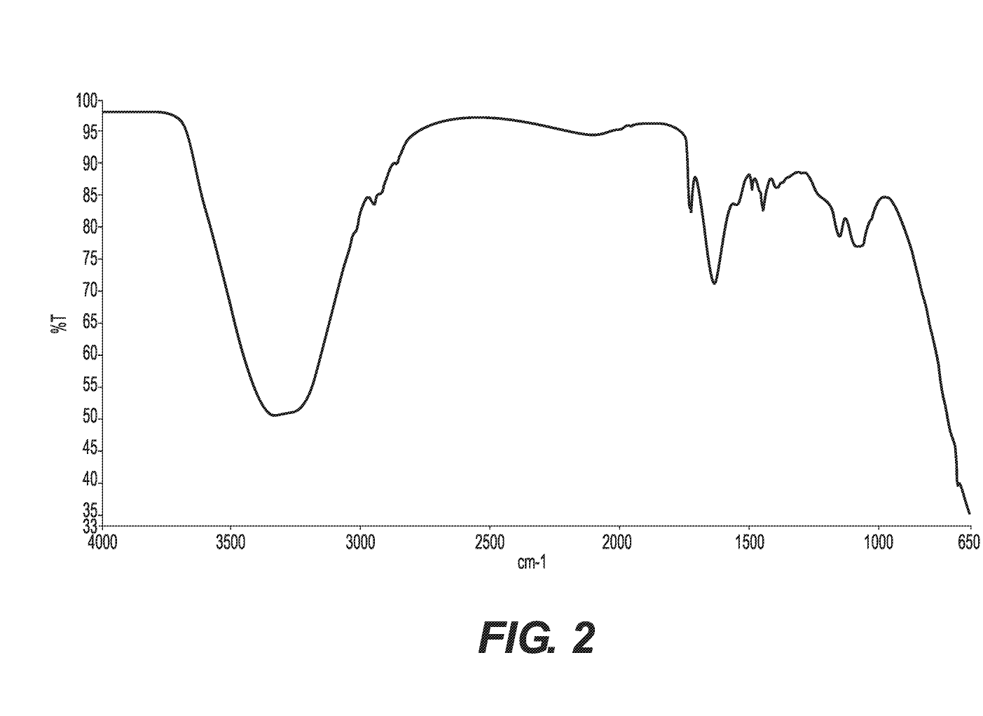

For example, the heat resistant composition can comprise or consist of from about 35% to about 55% by percent weight titanium dioxide, from about 20 to about 40% by percent weight a soft emulsion polymer based on styrene and acrylates (e.g. Induprint SE 2457), and the balance water. For example, the heat resistant composition can have the Fourier transform infrared (FTIR) spectroscopy shown in FIG. 2.

The heat resistant composition can further comprise or consist of from about 0.1% to about 20% by percent weight aluminum silicate filler (e.g. chemical name kaolin; e.g. Glomax LL) and/or from about 0.1% to about 10% by percent weight zinc oxide (ZnO).

For example, the heat resistant composition can comprise or consist of from about 40% to about 50% by percent weight titanium dioxide, from about 25 to about 35% by percent weight a soft emulsion polymer based on styrene and acrylates (e.g. Induprint SE 2457), and the balance water.

### Example #1

A heat resistant composition comprising or consisting of by percent weight:

| | |
|---|---|
| 47.6% | Titanium Dioxide (TiO₂); |
| 28.7% | soft emulsion polymer based on styrene and acylates; |
| 9.5% | Glomax LL; |
| 3.5% | Zinc Oxide (ZO); and |
| 10.7% | Water. |

### Example #2

A heat resistant coating composition for packaging, the heat resistant coating composition comprising or consisting of by percent weight:

| | |
|---|---|
| 47.6% | Titanium Dioxide (TiO₂); |
| 28.7% | Induprint SE 2457; |
| 9.5% | Glomax LL; |
| 3.5% | Zinc Oxide (ZO); and |
| 10.7% | Water. |

### Example #3

The heat resistant composition set forth in Example #1, made by mixing together the components set forth in Example #1 by stirring.

### Example #4

The heat resistant composition set forth in Example #1 comprising or consisting of the soft emulsion polymer based on styrene and acrylates having the Fourier transform infrared (FTIR) shown in FIG. 1.

### Example #5

The heat resistant composition set forth in Example #1 having the Fourier transform infrared (FTIR) shown in FIG. 2.

### Example #6

The heat resistant coating composition having the Fourier transform infrared (FTIR) shown in FIG. 2 coated on a paper substrate by a Gravure printing process.

I claim:

1. A method of making bakery white food packaging substrate, comprising:
providing a paper substrate;
coating on at least one side of the paper substrate a bakery white composition comprising from about 35% to 55% by percent weight titanium dioxide, from about 20% to about 40% by percent weight soft emulsion polymer based on styrene and acrylates, and the balance water.

2. A method of making bakery white food packaging substrate, comprising:
providing a paper substrate;
coating on at least one side of the paper substrate a bakery white composition comprising from about 35% to 55% by percent weight titanium dioxide, from about 20% to about 40% by percent weight soft emulsion polymer based on styrene and acrylates, and from about 0.1% to about 20% by percent weight kaolin; and the balance water.

3. A method of making bakery white food packaging substrate, comprising:
providing a paper substrate;
coating on at least one side of the paper substrate a bakery white composition comprising from about 35% to 55% by percent weight titanium dioxide, from about 20% to about 40% by percent weight soft emulsion polymer based on styrene and acrylates, from about 0.1% to about 20% kaolin by percent weight; and from about 0.1% to about 10% by percent weight zinc oxide, and the balance water.

4. A method of making bakery white food packaging substrate, comprising:
providing a paper substrate;
coating on at least one side of the paper substrate a bakery white composition comprising about 47.6% by percent weight titanium dioxide, about 28.7% by percent weight soft emulsion polymer based on styrene and acrylates, about 9.5% by percent weight kaolin; and from about 3.5% by percent weight zinc oxide, and the balance water.

5. The method according to claim 1, wherein the bakery white composition is from about 40% to about 50% by percent weight titanium dioxide.

6. The method according to claim 4, wherein the bakery white composition is about 47.6% by percent weight titanium dioxide.

7. The method according to claim 1, wherein the bakery white composition is from about 25% to about 35% by percent weight soft emulsion polymer based on styrene and acrylates.

8. The method according to claim 6, wherein the bakery white composition is about 28.7% by percent weight soft emulsion polymer based on styrene and acrylates.

9. The method according to claim 1, wherein the bakery white composition is from about 0.1% to about 20% by percent weight kaolin.

10. The method according to claim 8, wherein the bakery white composition is about 9.5% by percent weight kaolin.

11. The method according to claim 1, wherein the bakery white composition is about 0.1% to about 10% by percent weight zinc oxide.

12. The method according to claim 10, wherein the bakery white composition is about 3.5% by percent weight zinc oxide.

13. The method according to claim 1, wherein the coating is applied by rod coating.

14. The method according to claim 1, further comprising applying an overprint on the coating.

15. The method according to claim 14, wherein the overprint is a gloss overprint.

16. The method according to claim 1, further comprising printing on the coating.

17. The method according to claim 1, wherein the coating is applied by at least one selected from the group consisting of flexo printing and gravure printing.

18. The method according to claim 1, wherein the titanium oxide is Rutile Grade R-F9490.

19. The method according to claim 1, wherein the soft emulsion polymer based on styrene and acrylates having the Fourier transform infrared (FTIR)

20. A heat stable composition, comprising:
from about 35% to 55% by percent weight titanium dioxide;
from about 20% to about 40% by percent weight soft emulsion polymer based on styrene and acrylates; and
the balance water.

21. The composition according to claim 20, wherein the soft emulsion polymer based on styrene and acrylates is Induprint SE 2457.

22. The composition according to claim 20, further comprising from about 0.1% to about 20% by percent weight kaolin.

23. The composition according to claim 20, further comprising from about 0.1% to about 10% by percent weight zinc oxide.

24. The composition according to claim 22, further comprising from about 0.1% to about 10% by percent weight zinc oxide.

25. The composition according to claim 24, wherein the titanium oxide is from about 40% to about 50% by percent weight, the soft emulsion polymer based on styrene and acrylates is from about 25% to about 35% by percent weight, the kaolin is from about 5% to about 15% by percent weight; and the zinc oxide is from about 2% to about 8% by percent weight.

26. The composition according to claim 24, wherein the titanium oxide is about 47.6% by percent weight, the soft emulsion polymer based on styrene and acrylates is about 28.7% by percent weight, the kaolin is about 9.5% by percent weight; and the zinc oxide is about 3.5% by percent weight.

27. A food packaging substrate, comprising:
a paper substrate; and
a coating having the composition according to claim 20.
